(19) United States
(12) Patent Application Publication
(10) Pub. No.: US 2011/0029699 A1
(43) Pub. Date: Feb. 3, 2011

(54) Method and System for Routing Keystrokes in a Client Server Network

(76) Inventors: Craig S. Siegman, Pembroke Pines, FL (US); Brian S. Stewart, Tamarac, FL (US); David J. Cowen, Plantation, FL (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 12/533,073

(22) Filed: Jul. 31, 2009

(51) Int. Cl. G06F 3/00

(52) U.S. Cl. 710/38

(57) ABSTRACT

Methods and systems are provided that handle certain keystrokes or keystroke combinations on a remote station so that a user may select whether those keystrokes are sent to a target device, or whether they affect a remote station controlling the target device. Such systems allow the user to select which keystrokes, or keystroke combinations are sent to the target device, the remote station, or both. This allows the user the flexibility to tailor a remote KVM presence. These systems intercept keystrokes entered on the remote station and route them according to pre-selected criteria determined by the user. To intercept the keystrokes the software running on the remote station installs a low-level keyboard hook. This hook allows the software to view and route the keystrokes before the remote station's operating system gets notified of the keystroke.

This generally relates to remote computer systems and more particularly to keystroke routing on remote devices in a client server network.

### BACKGROUND

Systems exist to facilitate remote control of and access to a computer by an operator at a remote station. Such systems typically use a device or mechanism that enables an operator at a remote station to control aspects of a so-called target (or local) computer. More particularly, such systems typically allow a remote station to provide mouse and keyboard input to the target computer and further allow the remote station to view the video display output. These types of systems are typically called keyboard-video-mouse (KVM) systems.

In the discussion that follows, the computer or system being controlled or accessed is generally referred to as the target computer or the target system. In some instances, the target computer is also referred to as the local computer. The system that is being used to access or control the target (local) computer is generally referred to herein as the remote system. For convenience of description, components on or connected directly to the target computer are referred to herein as “local,” whereas components that are on or connected directly to the remote system are referred to herein as “remote.”

A KVM system has a program that runs on the remote station that presents the video image to a user and allows that user to interact with the target system through keyboard and mouse inputs. Ideally, the keyboard input would allow the user to enter any keystroke, or combination of keystrokes, and send those keystrokes directly to the target device without intervention or reaction by the remote station. If the keyboard input did this, however, the user would not be able to use certain keystrokes, or combinations of keystrokes to affect the remote station. For example, the keystroke combination of ALT-TAB is used by both the Linux and Windows operating systems to allow a user to switch among desktop windows. If the remote station uses that keystroke combination to switch among the remote station's desktop windows, it would typically be ill-advised to allow that same keystroke combination to be transmitted to the target device where it would cause the same action by switching among windows on the target device's desktop. Similarly, if it is desired to transmit the keystroke combination to the target device so that the windows on the target device's desktop can be switched, then it would be ill-advised to allow the client's workstation to react to that keystroke combination and cause the windows to switch and potentially block the view of, and interaction with, the target device. When using a remote KVM client application the user faces the dilemma of routing all keystrokes to the target device, or routing only a subset over which he or she has no control.

Accordingly, there is a desire for a system to handle certain keystrokes or keystroke combinations in a remote station remotely controlling a target device.

### SUMMARY

In accordance with methods and systems consistent with the present invention, a data processing system for routing keystrokes is provided comprising an input configured to receive a first indication of one or more keystrokes of a keyboard to be routed to a client device, and configured to receive a second indication of one or more keystrokes of the keyboard to be routed to a target device. The data processing system further comprises a memory configured to store the received first and second indications, and a keyboard comprising keys and receiving one or more keystrokes by a user on one or more of the keys. The data processing system additionally comprises a processor configured to determine whether the received one or more user keystrokes are to be routed to a client device or a target device, based on the received first and second indications, and the client device is configured to receive the one or more user keystrokes based on the first indication.

In another implementation, a method in a data processing system for routing keystrokes is provided comprising receiving a first indication of one or more keystrokes on a keyboard to be routed to a client device, and receiving a second indication of one or more keystrokes on the keyboard to be routed to a target device. The method further comprises storing the first and second received indications, receiving one or more keystrokes by a user, and determining whether the received one or more user keystrokes are to be routed to the client device based on the received first indication. Finally, the method also comprises routing the received one or more keystrokes to the client device based on the determination, determining whether the received one or more keystrokes are to be routed to the target device based on the received second indication, and routing the received one or more keystrokes to the target device based on the determination.

In accordance with another implementation, a method in a data processing system for routing keystrokes is provided comprising receiving an indication of one or more keystrokes to be routed to a target device from a user, and receiving one or more keystrokes on a keyboard by the user. The method further comprises routing the one or more received user keystrokes to the target device based on the received indication.

### BRIEF DESCRIPTION OF THE DRAWINGS

FIG. 1 illustrates an exemplary KVM computer system network in accordance methods and systems consistent with the present invention

FIG. 2 illustrates an exemplary target computer system consistent with systems and methods consistent with the present invention.

FIG. 3 depicts an exemplary keyboard in accordance with methods and systems consistent with the present invention.

FIG. 4 illustrates steps in a method for assigning and using keystroke combinations in conjunction with a client and target computer in accordance with methods and systems consistent with the present invention.

### DETAILED DESCRIPTION

Methods and systems in accordance with the present invention provide a way to handle certain keystrokes or keystroke combinations on a remote station so that a user may select whether those keystrokes are sent to the target device, or whether they affect the remote station, or both. These systems intercept keystrokes entered on the remote station and route them according to pre-selected criteria determined by the user. The user may select to route the keystrokes to the target device only, to route the keystrokes to the remote station only, or to route the keystrokes to both the remote station and the target device (although typically not advisable). This allows the user the flexibility to tailor the remote KVM presence.

To intercept the keystrokes, software running on the remote station installs a low-level keyboard hook or driver. This hook allows the software to view and route the keystrokes before the remote station's operating system gets notified of the keystroke. Based on the selection made by the user concerning the routing of certain keystrokes, or combinations of keystrokes, the software then determines whether to send the keystroke(s) directly to the target device, whether to send them to the remote station's operating system, or whether to send them to both. The user selects which keystrokes, or combinations of keystrokes, to send directly to the target device, which to send to the remote station's operating system, and which to send to both through a series of onscreen dialog boxes. The settings the user selects may be retained permanently and may apply to, in one implementation, all digital KVM sessions that the user may conduct. In one implementation, the keystrokes available for such selection include, for example: (1) ALT-TAB, (2) ALT-ESC, (3) PrtScr, (4) ScrLk, (5) Pause/Break, (6) NumLock, (7) Windows key, (8) Application Menu Key, and (9) ALT-UR (European keyboards).

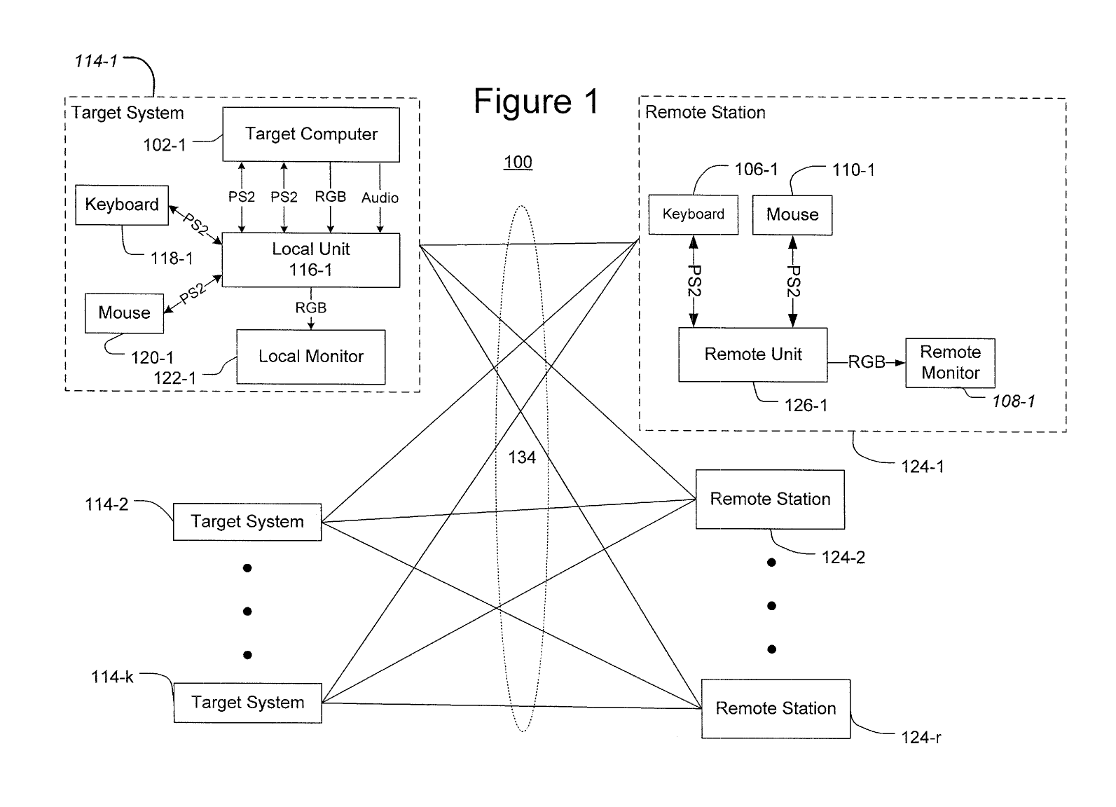

FIG. 1 illustrates depicts an exemplary KVM computer system in accordance methods and systems consistent with the present invention. A KVM system 100 is shown in FIG. 1, where one or more target systems 114-1 . . . 114-k are controlled or accessed by one or more remote stations 124-1, 124-2, . . . 124-r (generally 124). Each target system 114 includes a target computer 102 with associated and attached local unit 116. Each remote station 124 generally includes a remote unit 126, a keyboard 106, a video monitor 108 and a mouse (or similar point-and-click device) 110, although some remote stations may only include a video display 108 and a remote unit. Operation of a particular target computer 102-i may be remotely viewed on the video monitor 108 of any of the remote stations 124, and the keyboard 106 and mouse 110 of the remote station 124 may be used to provide keyboard and mouse input to the target computer 102-i. As shown in FIG. 1, in a KVM system 100, a remote station 124 is able to control or access more than one target computer. Note that the lines drawn between target systems and remote stations in FIG. 1 represent potential (and not necessarily actual) wired or wireless (e.g., RF) links between those sides. Thus, each target computer 102 may be controlled or accessed by more than one remote station 124, and each remote station 124 may control more than one target computer 102. The remote station, in one implementation, may be located within several hundred feet of the target system.

Furthermore, in certain contexts, the target system is considered to be a video transmitter or sending unit, and the remote system is the video receiving unit or receiver, although both units transmit and receive. Generally, video travels from target system to remote station, while keyboard and mouse data move from remote station to target system.

As shown in FIG. 1 the local or target system 114 includes a target computer 102 and an associated local unit 116. The local system 114 may also include a keyboard 118, a mouse (or other point-and-click-type device) 120 and a local monitor 122, each connected to the local unit 116 directly. The remote station 124 includes a remote unit 126. The local or target computer 102 may be a computer, a server, a processor or other collection of processors or logic elements. Generally, a target computer 102 may include any processor or collection of processors. By way of example, a target computer 102 may be a processor or collection of processors or logic elements located (or embedded) in a server, a desktop computer (such as a PC, Apple Macintosh or the like), a kiosk, an ATM, a switch, a set-top box, an appliance (such as a television, DVR, DVD player and the like), a vehicle, an elevator, on a manufacturing or processing production line. A collection of target computers 102 may, e.g., be a collection of servers in a rack or some other collection, they may be independent of each other or connected to each other in a network or by some other structure. The local and remote monitors 122, 108, may be digital or analog.

The local unit 116 is a device or mechanism, e.g., a printed circuit board (“PCB”), that is installed locally to the target/local computer 102. This device may be close to, but external to the computer, or may be installed inside the computer's housing. Regardless of the positioning of the local unit 116, in one implementation, there is a direct electrical connection between the target computer 102 and the local unit 116.

Various components on the local/target system 114 communicate wirelessly or via a wired connection with components on the remote station 124 via a wireless connection link 134. In one implementation, the wireless connection or link 134 follows the IEEE 802.11a standard protocol, although one skilled in the art will realize that other protocols and methods of communication are possible.

The local unit 116 receives local mouse and keyboard signals, e.g., as PS2 signals or USB signals. These signals are provided by the local unit 116 to the target computer 102. The target computer 102 generates video output signals, e.g., RGB (Red, Green, Blue) signals, which are provided to the local unit 116 which, in turn, provides the signals to drive the local monitor 122. The target computer 102 may also generate audio output signals which are provided to the local unit 116. As noted, the target computer 102 need not have a keyboard, mouse or monitor, and may be controlled entirely by a remote station 124.

Local unit 116 transmits image data for transmission to a remote station (e.g., via remote unit 126). Some or all of the data may be compressed before being transmitted. Additionally, local unit 116 may receive mouse and keyboard data (from a remote station 124), which is then provided to the local/target computer 102. The target computer 102 may execute the data received and may display output on its local monitor 122.

The remote station 124 receives video data from the local unit 116 of the target computer 102, via a wired or wireless connection (e.g., 802.11a wireless connection 134). The remote unit 126 receives (possibly compressed) video from the local unit 116. The remote unit 126 decompresses (as necessary) the video from the local unit 116 and provides it to the appropriate rendering device, e.g., to the remote monitor 108, which displays the video data, and to the remote speakers 109, respectively. Additionally, remote mouse 110 and keyboard 106 may be used to generate appropriate signals (e.g., PS2 signals) that may be transmitted via remote unit 126 to local unit 116 for execution on target computer 102.

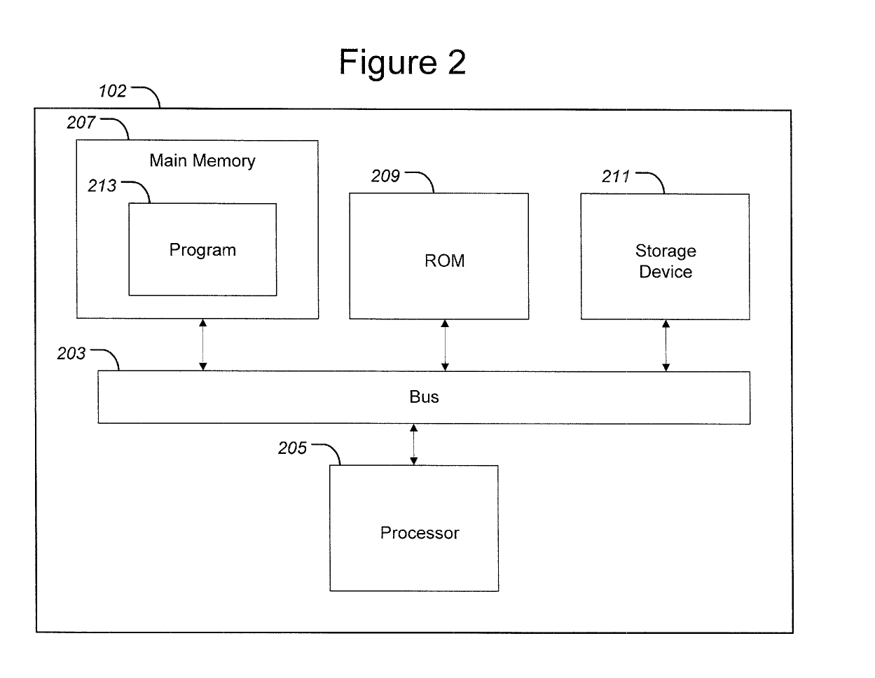

FIG. 2 illustrates an exemplary target computer system consistent with systems and methods consistent with the present invention. Target computer 102 includes a bus 203 or other communication mechanism for communicating information, and a processor 205 coupled with bus 203 for processing the information. Remote station 124 may also include similar components as target computer 102, including some or all of the components mentioned. Target computer 102 also includes a main memory 207, such as a random access memory (RAM) or other dynamic storage device, coupled to bus 203 for storing information and instructions to be executed by processor 205. In addition, main memory 207 may be used for storing temporary variables or other intermediate information during execution of instructions to be executed by processor 205. Main memory 207 includes a program 213 for implementing processing consistent with methods and systems in accordance with the present invention. Main memory 207 on remote station 124 may also store the low level keyboard hook as mentioned, and/or user's settings as described below. Target computer 102 further includes a Read-Only Memory (ROM) 209 or other static storage device coupled to bus 203 for storing static information and instructions for processor 205. A storage device 211, such as a magnetic disk or optical disk, is provided and coupled to bus 203 for storing information and instructions.

According to one embodiment, processor 205 executes one or more sequences of one or more instructions contained in main memory 207. Such instructions may be read into main memory 207 from another computer-readable medium, such as storage device 211. Execution of the sequences of instructions in main memory 207 causes processor 205 to perform processes described herein. One or more processors in a multi-processing arrangement may also be employed to execute the sequences of instructions contained in main memory 207. In alternative embodiments, hard-wired circuitry may be used in place of or in combination with software instructions. Thus, embodiments are not limited to any specific combination of hardware circuitry and software.

Although described relative to main memory 207 and storage device 211, instructions and other aspects of methods and systems consistent with the present invention may reside on another computer-readable medium, such as a floppy disk, a flexible disk, hard disk, magnetic tape, a CD-ROM, magnetic, optical or physical medium, a RAM, a PROM, and EPROM, a FLASH-EPROM, any other memory chip or cartridge, or any other medium from which a computer can read, either now known or later discovered.

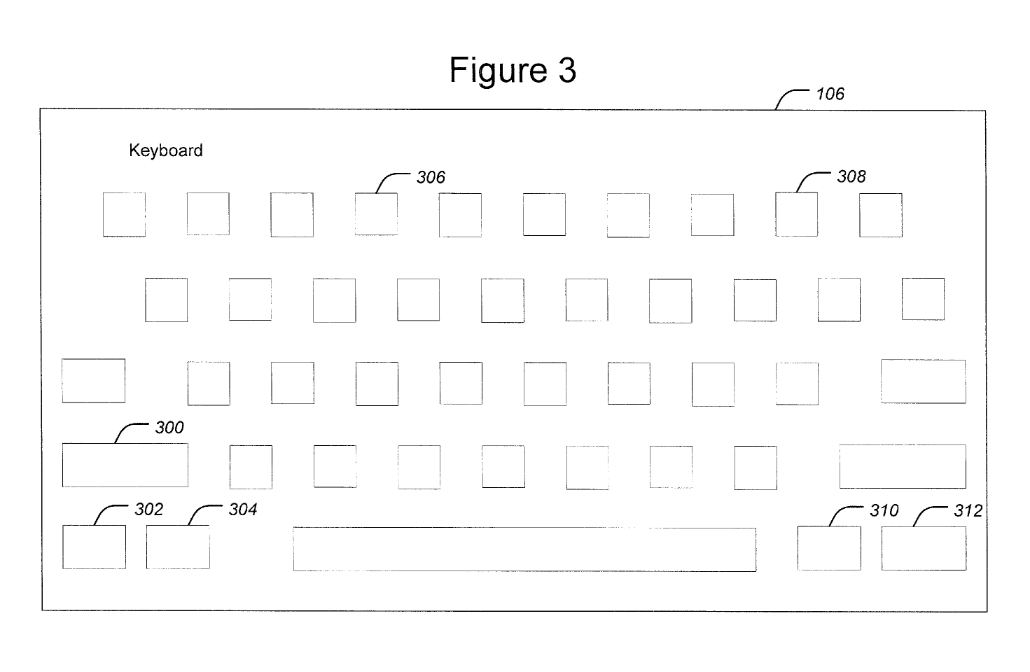

FIG. 3 depicts an exemplary keyboard 106 in accordance with methods and systems consistent with the present invention. Several keys 300-312 are shown on the keyboard 106, and the keyboard may have many other keys than the ones shown. Also, on FIG. 3, many of the keys are not labeled with numerals. The keyboard 106 may be any suitable keyboard or other input device.

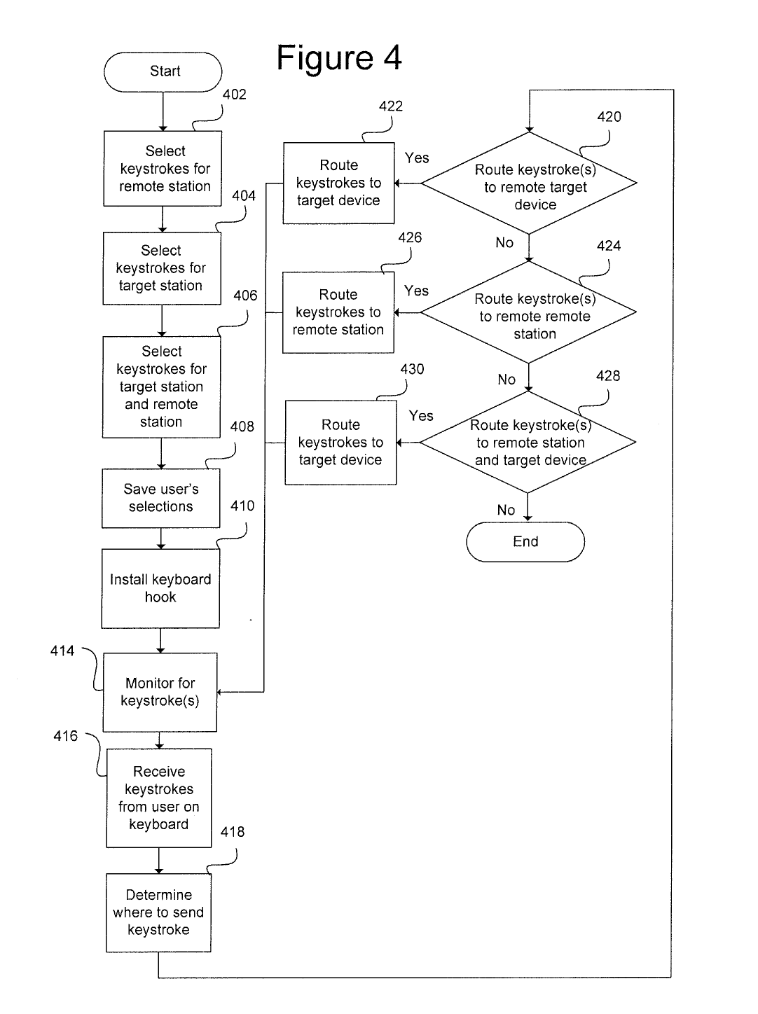

FIG. 4 illustrates steps in a method for assigning and using keystroke combinations in conjunction with a remote station and target computer in accordance with methods and systems consistent with the present invention. First, using a series of onscreen dialog boxes in one implementation, a user selects one or more keystrokes to be routed to the remote station 124 (step 402). For example, the user may select keys 300-304 to be assigned to the remote station 124. The user may also select one or more keystrokes to be routed to a target system 114 (step 404). For example, the user may select keys 306-312 to be assigned to the target system 114. Additionally, although typically not advisable, the user may also select one or more keystrokes to be routed to both the remote station 124 and the target system 114 (step 406).

The system saves the user's setting for this session and future sessions for this user (step 408). The remote station 124 installs a low level keyboard hook (step 410) which the system uses the hook to monitor keystrokes (step 412) and to and route them before the remote station is notified of the keystrokes. The keyboard 106 of the system then receives keystrokes from the user (step 414).

The system determines whether to send the keystroke to the target system 114, the remote station 124, or both (step 418). If the received keystrokes are to be routed to the target system 114 (step 420), the system routes those keystrokes to the target system 114 (step 422). In this example, if the user types keys 306-312 it will be routed to the target system 114.

Alternatively, if the received keystrokes are to be routed to the remote station 124 (step 424), the system routes the keystrokes to that workstation (step 426). In this example, however, if the user types keys 300-304 it will be routed to the remote station 124. If the received keystrokes were denoted by the user to be routed to both the target system 114 and the remote station 124 (step 428), they are routed to both (step 430). Finally, the system then continues to monitor for additional keystrokes (step 414).

In one implementation, the decision where to route the keystrokes is not made until all the keystrokes have been entered. For example, if ALT-TAB is to be routed to the target system 114, but ALT-ESC is not, then the ALT keystroke is not transmitted until the next keystroke has been received by the remote station 124. Once the desired keystrokes have been entered, they are routed as intended with each keystroke being transmitted in order to the appropriate destination.

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A data processing system for routing keystrokes, comprising:
an input configured to receive a first indication of one or more keystrokes of a keyboard to be routed to a client device, and configured to receive a second indication of one or more keystrokes of the keyboard to be routed to a target device;
a memory configured to store the received first and second indications; and
a keyboard comprising keys and receiving one or more keystrokes by a user on one or more of the keys;
a processor configured to determine whether the received one or more user keystrokes are to be routed to one of: (1) a client device and (2) a target device, based on the received first and second indications; and
the client device configured to receive the one or more user keystrokes based on the first indication.

2. The data processing system of claim 1 further comprising a target device configured to receive the one or more user keystrokes based on the second indication.

3. The data processing system of claim 1, wherein received first and second indications are saved in the memory for use in a second session with the user.

4. The data processing system of claim 1, wherein the memory includes a low level keyboard hook configured to facilitate routing of the received one or more user keystrokes to one of: (1) the target device and (2) the client device.

5. The data processing system of claim 4, wherein the lower level keyboard hook receives the one or more user keystrokes before the one or more user keystrokes are sent to the client device.

6. The data processing system of claim 5, wherein the lower level keyboard hook monitors the keyboard for input by the user.

7. A method in a data processing system for routing keystrokes, comprising:
receiving a first indication of one or more keystrokes on a keyboard to be routed to a client device;
receiving a second indication of one or more keystrokes on the keyboard to be routed to a target device;
storing the first and second received indications;
receiving one or more keystrokes by a user;
determining whether the received one or more user keystrokes are to be routed to the client device based on the received first indication;
routing the received one or more keystrokes to the client device based on the determination;
determining whether the received one or more keystrokes are to be routed to the target device based on the received second indication; and
routing the received one or more keystrokes to the target device based on the determination.

8. The method of claim 7, further comprising:
routing the one or more keystrokes to both the target device and the client device.

9. The method of claim 7, further comprising:
receiving the one or more user keystrokes based on the second indication.

10. The method of claim 7, further comprising:
facilitating routing of the received one or more user keystrokes to one of: (1) the target device and (2) the client device.

11. The method of claim 7, further comprising:
receiving the one or more user keystrokes before the one or more user keystrokes are sent to the client device.

12. The method of claim 7, further comprising:
monitoring the keyboard for input by the user.

13. The method of claim 7, wherein received first and second indications are saved in the memory for use in a second session with the user.

14. A method in a data processing system for routing keystrokes, comprising:
receiving an indication of one or more keystrokes to be routed to a target device from a user;
receiving one or more keystrokes on a keyboard by the user; and
routing the one or more received user keystrokes to the target device based on the received indication.
